(19) United States
(12) Patent Application Publication
(10) Pub. No.: US 2014/0361529 A1
(43) Pub. Date: Dec. 11, 2014

(54) PIPELINE EXPANSION LOOP PROTECTOR

(71) Applicant: Daniel George McCormick, Fort St. John (CA)

(72) Inventor: Daniel George McCormick, Fort St. John (CA)

(21) Appl. No.: 13/912,044

(22) Filed: Jun. 6, 2013

(51) Int. Cl. F16L 51/00

(52) U.S. Cl. CPC F16L 51/00
USPC 285/55

(57) ABSTRACT

An apparatus, kit and for permitting an underground pipeline to expand. The apparatus comprises a sheet of material extending between first and second sides and first and second ends. The sheet of material has a plurality of slots extending from each of the first and second sides towards each other. The kit comprises a front compressible body having a shape corresponding to an outside radius of a pipe elbow and the sheet of material wherein the sheet has a length and width sufficient to be wrapped into a u-shape member extending around the compressible material and the pipe elbow. The compressible material is formed of foam. The method comprises providing the front compressible body proximate to an outside bend in a pipe elbow and wrapping the sheet of material thereabout with the front compressible body and pipe elbow therein.

### BACKGROUND OF THE INVENTION

1. Field of Invention

The present invention relates generally to pipeline protection in general and in particular to a method and apparatus for protecting a pipe during expansion and contraction.

2. Description of Related Art

Pipe expansion and contraction under changes in temperature is a common concern for many installations. In particular, the fluid which is transported by the pipe may have an elevated temperature which will cause the pipe to expand. It is well known that such expansion causes the pipe to increase in length thereby potentially damaging the pipe. Commonly such expansion of the pipe will be most prominent at the corners or elbows of the pipe as well as within any installed expansion loops.

One common difficulty of such pipe expansion is in the case of underground buried pipes. In such situations, the pipe will be covered with a quantity of soil or other material so as to cover and conceal the pipe from common viewing. Disadvantageously, when such backfill soil material is placed around the pipe, it will also be commonly located around the elbow or expansion joint, thereby limiting the degree to which the pipe will be permitted to expand. An additional, it will be appreciated that pipes buried underground may be subject to damage from the surrounding and overlaid backfill soil due to impact or abrasion during the aforementioned expansion and contraction such as, by way of non-limiting example, scratching or chipping of the pipe coating material.

One common approach to permitting a buried pipe to expand is to provide a compressible material, such as, by way of non-limiting example, expanded foam around the outside bend of the pipe to provide a region into which the pipe may be permitted to expand. It will be appreciated that such compressible material will commonly be located around the pipe prior to backfilling and will therefore be covered and surrounded by the overlying backfill soil.

Disadvantageously, as the compressible materials are commonly covered by the backfill soil, such soil may enter any space between the pipe and the compressible material during such backfilling operation. Additionally, it will be appreciated that during cyclical expansion and contraction of the pipe, additional soil may enter such spaces between the pipe and the compressible material. Such soil entering the spaces between the compressible material, as well as potentially entering the voids in the compressible material itself reduces isolates the pipe from the compressible material thereby reducing the effectiveness of such material as well as the potentially reducing the compressibility of the material itself.

### SUMMARY OF THE INVENTION

According to a first embodiment of the present invention there is disclosed an apparatus for permitting an underground pipeline to expand comprising a sheet of material extending between first and second sides and first and second ends. The sheet of material has a plurality of slots extending from each of the first and second sides towards each other.

Each slot may extend to a distal end. The distal ends of the slots may include strain relief bores. The slots may be arranged in matched pairs extending from each of the first and second sides. The matched pairs of slots may be substantially aligned with each other.

The slots may extend to a distance sufficient to leave a common gap distance therebetween. The gap distance may extend parallel to the first and second sides. The gap distance may be selected to be between 1 and 4 inches. The sheet may have first and second surfaces wherein the slots have chamfered edges adjacent to the first surface.

The sheet may be formed of plastic. The sheet may have a thickness of between ⅛ and ⅜ of an inch.

According to a further embodiment of the present invention there is disclosed a kit for permitting an underground pipeline to expand comprising a rear compressible body having a shape corresponding to an outside bend of a pipe elbow and a sheet of material extending between first and second sides and first and second ends. The sheet of material has a plurality of slots extending from each of the first and second sides towards each other wherein the sheet has a length and width sufficient to be wrapped into a u-shape member extending around the rear compressible body and the pipe elbow.

The kit may further comprise a front compressible body corresponding to an inside radius of the pipe elbow. The kit may further comprise a plurality of straps sized to extend around the sheet, the rear and the front compressible bodies and the pipe. The front and rear compressible bodes may be formed of foam.

According to a further embodiment of the present invention there is disclosed a method for permitting an underground pipeline to expand comprising providing a body of compressible material proximate to an outside bend in a pipe elbow and wrapping a sheet of material extending between first and second sides and first and second ends into a u-shaped cross section with the compressible material and pipe elbow therein. The sheet of material has a plurality of slots extending from each of the first and second sides towards each other. The method may further comprise backfilling a soil material over the sheet of material.

The method may further comprise providing a front compressible body corresponding to an inside radius of the pipe elbow. The method may further comprise wrapping a plurality of straps around the sheet, the rear and the front compressible bodies and the pipe.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a cross sectional view of an apparatus for permitting an underground pipe to expand as installed around an underground pipe.

FIG. 2 is a cross sectional view of an apparatus for permitting an underground pipe to expand as installed around an underground pipe.

FIG. 3 is a perspective view of the apparatus of FIG. 1.

FIG. 4 is a top plan view of the apparatus of FIG. 2.

FIG. 5 is a detailed cross-sectional view of the apparatus of FIG. 2 as taken along the line 4-4 of FIG. 3.

### DETAILED DESCRIPTION

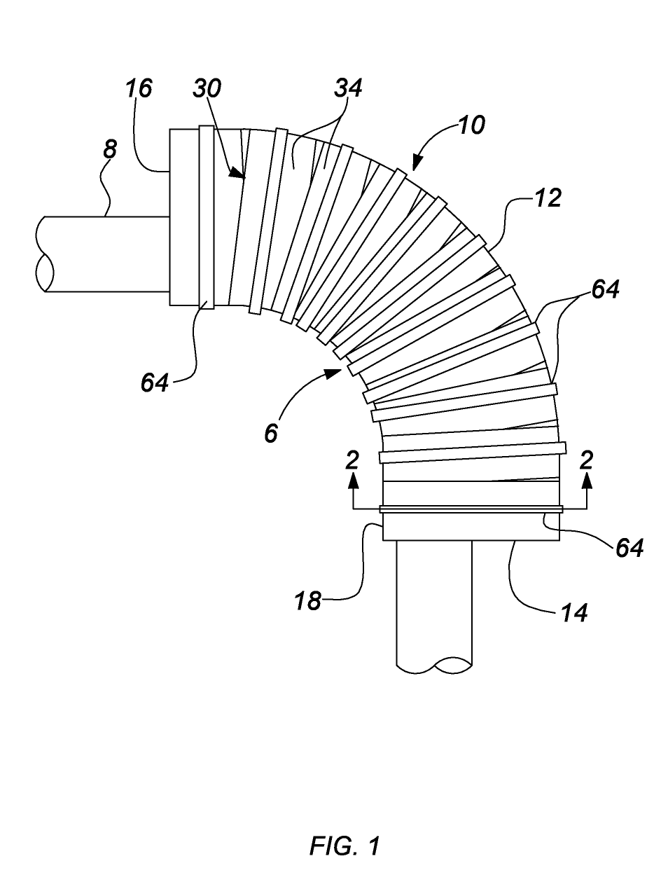

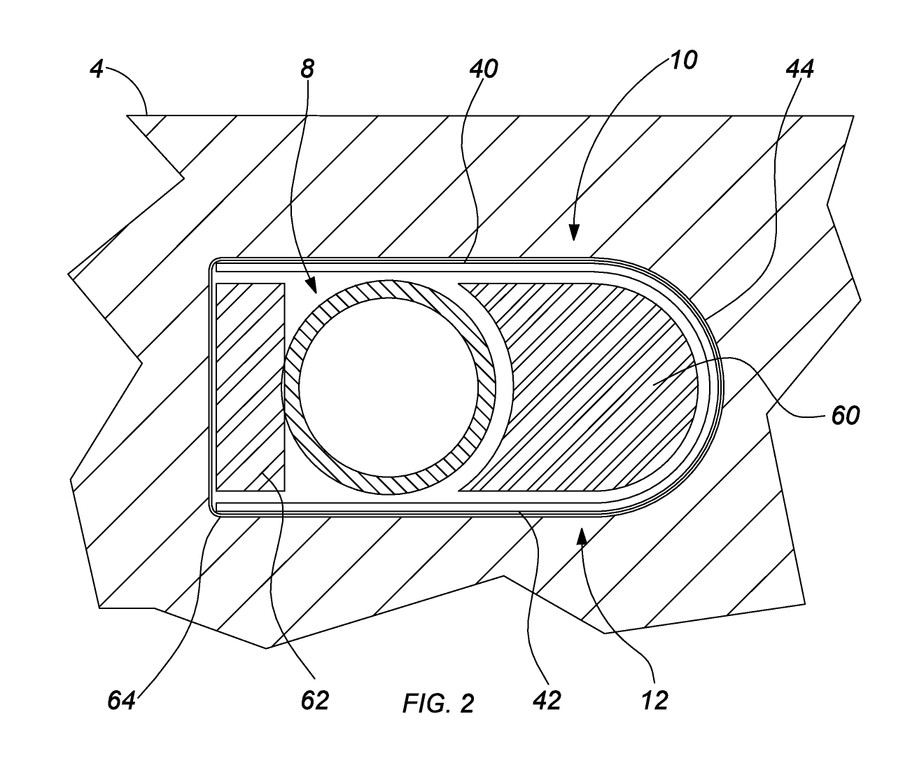

Referring to FIG. 1, an apparatus for permitting expansion of a pipe 8 according to a first embodiment of the invention is shown generally at 10. The apparatus comprises a sheet 12 of material having plurality of slots 30 therein so as to be deformed into an arcuate u-shape as illustrated in FIGS. 1 and 2. The sheet 12 is sized to extend around both the top and bottom of the pipe 8 as well as a rear compressible body 60 located between the sheet 12 and the pipe 8 as illustrated in FIG. 2.

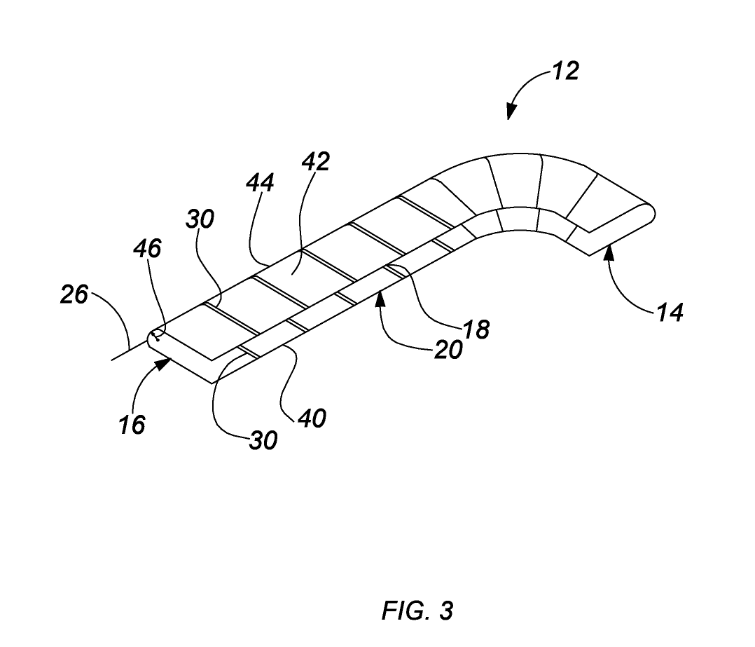

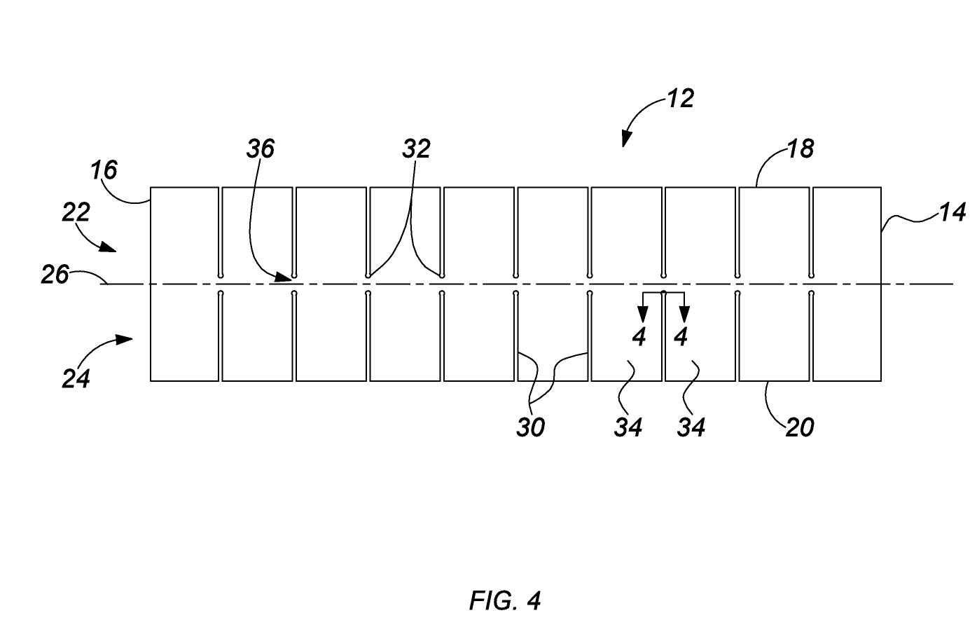

With reference to FIGS. 3 and 4, the sheet 12 has first and second surfaces, 22 and 24, respectively and is formed of a flexible material 12. As illustrated in FIG. 4, the sheet 12 extends between first and second ends, 14 and 16 respectively and first and second side edges, 18 and 20, respectively. The first and second side edges 18 and 20 may be perpendicular to the first and second ends 14 and 16 so as to be substantially rectangular, although it will be appreciated that other shapes may also be utilized as well, such as, by way of non-limiting example, trapezoidal or parallelogram. The sheet 12 has a length between the first and second ends 14 and 16 selected to extend around the outside elbow 6 of a pipe 8 as illustrated in FIG. 2. In particular, the sheet 12 may have a length selected to extend for a length greater than the outside radius of the pipe 8 with a rear compressible body 60 located therebetween as will be further described below. By way of non-limiting example, the sheet 12 may have a length of up to 120 inches (3050 mm) or more.

The sheet 12 also has a width between the first and second side edges 18 and 20 sized to be folded into a u-shaped cross section as illustrated in FIG. 3 sized to extend around the top and bottom of a pipe 8 with a rear compressible body 60 located therebetween. As illustrated in FIG. 3, when folded into the u-shaped cross section, the sheet 12 will have top and bottom substantially flat portions, 40 and 42, respectively with an arcuate portion 44 therebetween. The arcuate portion 44 has a radius, generally indicated at 46 corresponding to the radius of the pipe 8. By way of non-limiting example, for a pipe 8 having a radius of approximately 4 inches (102 mm) a width of between 30 and 40 inches (762 and 1016 mm) has been found to be adequate.

As illustrated in FIG. 4, the sheet 12 includes a plurality of slots 30 extending from each of the first and second side edges 18 and 20 in a direction generally towards each other. As illustrated in FIG. 4, the slots 30 may extend substantially perpendicularly from the first and second edges however it will be appreciated that the slots 3 may also extend at an angle relative to the first and second side edges 18 and 20 to facilitate bending of the sheet 12 around a pipe elbow 6 as further described below. Each slot 30 may include a strain relieving bore 32 at a distal end thereof as are commonly known in the art. As illustrated in FIG. 4, the slots define flaps 34 therebetween the purpose of which will be more fully described below. The slots 30 extend from the first and second side edges 18 and 20 at regular spaced apart intervals so as to create substantially evenly sized flaps 34. By way of non-limiting example, the slots 30 may be spaced along the first and second edges to form flaps 34 having a width of between 6 and 24 inches (152 and 610 mm). The slots 30 and bores 32 may have a width selected to assist in the flaps 34 in overlapping each other as described below. In particular the slots may have a width of up to ½ inch (12 mm) and a bore having a diameter of up to 1 inch (25 mm).

The slots 30 are arranged so as to be substantially aligned with a corresponding slot from the opposed side. As illustrated in FIG. 4, the strain relieving bores 32 are spaced apart from each other by a gap distance 36 along a center line 26 of the sheet. The slots 30 may each have a common length so as to form a gap distance therebetween which is common along the length of the sheet. The gap distance 36 will be selected to maintain the sheet 12 as a cohesive article as well as to provide flexibility of the sheet when applied to a pipe elbow 6 as described below. In particular it has been found that a gap distance of between 1 and 4 inches (25 and 102 mm) has been useful.

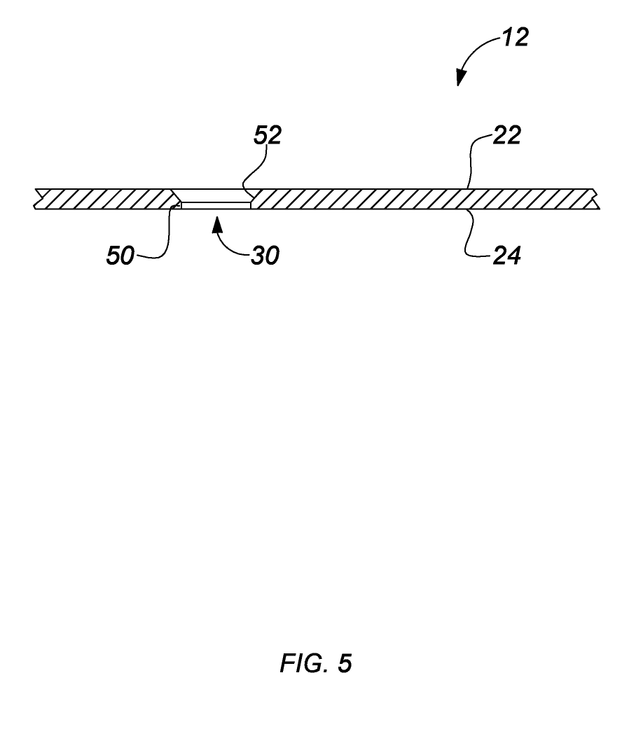

Turning now to FIG. 5, a cross sectional view of the slot as taken along the line 4-4 is illustrated. The slot 30 may include a bottom section 50 having edges substantially perpendicular to the first and second surfaces 22 and 24. The slot 30 may also include a top portion 52 having chamfered edges as illustrated in FIG. 5 so as to facilitate sliding of one flap 34 over another as will be more fully described below. The sheet 12 may be formed of any suitable flexible material, such as, by way of non-limiting example, plastics, such as polyurethane, polyethylene or polyethylene terephthalate as well as natural or synthetic rubbers, composite materials or impregnated fabrics. The sheet 12 may have any thickness suitable to support soil around the pipe 8 as well as to remain flexible, such as, by way of non-limiting example, between ⅛ and ½ inches (3 and 12 mm).

The rear compressible body 60 a body of a substantially compressible material, such as foam or the like which may be formed to conform to the shape of the pipe elbow. As illustrated in FIG. 2, the kit may also include a front compressible body 62 formed of a similar material to the rear compressible body 60 which may formed or otherwise located proximate to an inside bend of the elbow.

In operation, a user may locate a pipe 8 having an elbow 6 within an excavation. Thereafter a rear compressible body 60 may be located around the outside radius of the elbow 6 as illustrated in FIG. 2. To protect the rear compressible body 60 the sheet 12 may be folded about the center line 26 into a u-shaped profile. Thereafter the u-shaped profile may be curved as illustrated in FIG. 3 so as to overlap successive flaps 34 onto each other. The sheet 12 may then be located around the pipe elbow 6 and the front compressible rear compressible body 60. Optionally, a front compressible body 62 may be located proximate to the inside radius of the elbow as well and the sheet 12 secured around the pipe and compressible bodies with strapping 64, tape or the like. Thereafter the pipe and sheet assembly may be covered with soil 4. When positioned in such a manner, the pipe 8 will be permitted to expand by compressing the rear compressible body 60 and to contract by moving away from the sheet. It will be observed that during such contraction, the sheet 12 will prevent soil and the like from entering any space between the pipe 8 and the compressible body thereby ensuring that the pipe can thereafter expand again. It will also be appreciated that the sheet 12 will serve to protect surface coating of the pipe from impacts with rocks or the like during backfilling of the excavation as well as from abrasion against the soil formation during cyclical expansion and contraction of the pipe by isolating the pipe from such soil formations.

While specific embodiments of the invention have been described and illustrated, such embodiments should be considered illustrative of the invention only and not as limiting the invention as construed in accordance with the accompanying claims.

What is claimed is:

1. An apparatus for permitting an underground pipeline to expand comprising a sheet of material extending between first and second sides and first and second ends, said sheet of material having a plurality of slots extending from each of said first and second sides towards each other.

2. The apparatus of claim 1 wherein each slot extends to a distal end.

3. The apparatus of claim 2 wherein said distal ends of said slots include strain relief bores.

4. The apparatus of claim 1 wherein said slots are arranged in matched pairs extending from each of said first and second sides.

5. The apparatus of claim 4 wherein said matched pairs of slots are substantially aligned with each other.

6. The apparatus of claim 1 wherein said slots extend to a distance sufficient to leave a common gap distance therebetween.

7. The apparatus of claim 6 wherein said gap distance extend parallel to said first and second sides.

8. The apparatus of claim 7 wherein said gap distance is selected to be between 1 and 4 inches.

9. The apparatus of claim 1 wherein said sheet has first and second surfaces wherein said slots have chamfered edges adjacent to said first surface.

10. The apparatus of claim 1 wherein said sheet is formed of plastic.

11. The apparatus of claim 1 wherein said sheet has a thickness of between ⅛ and ⅜ of an inch.

12. A kit for permitting an underground pipeline to expand comprising:
a rear compressible body having a shape corresponding to an outside radius of a pipe elbow; and
a sheet of material extending between first and second sides and first and second ends, said sheet of material having a plurality of slots extending from each of said first and second sides towards each other, wherein said sheet has a length and width sufficient to be wrapped into a u-shape member extending around said rear compressible body and said pipe elbow.

13. The kit of claim 12 further comprising a front compressible body corresponding to an inside radius of said pipe elbow.

14. The kit of claim 13 further comprising a plurality of straps sized to extend around said sheet, said rear and said front compressible bodies and said pipe.

15. The kit of claim 13 wherein said front and rear compressible bodes are formed of foam.

16. A method for permitting an underground pipeline to expand comprising
providing a rear compressible body proximate to an outside radius in a pipe elbow;
wrapping a sheet of material extending between first and second sides and first and second ends into a u-shaped cross section with said rear compressible body and pipe elbow therein, said sheet of material having a plurality of slots extending from each of said first and second sides towards each other; and
backfilling a soil material over said sheet of material.

17. The method of claim 16 further comprising providing a front compressible body corresponding to an inside radius of said pipe elbow.

18. The method of claim 17 further comprising wrapping a plurality of straps around said sheet, said rear and said front compressible bodies and said pipe.
